(19) United States
(12) Patent Application Publication
(10) Pub. No.: US 2008/0184365 A1
(43) Pub. Date: Jul. 31, 2008

(54) INFORMATION PROCESSING METHOD, INFORMATION PROCESSING APPARATUS, INFORMATION PROCESSING PROGRAM, AND RECORDING MEDIUM ON WHICH THE PROGRAM IS RECORDED

(75) Inventor: Kozo Matsushita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/020,017

(22) Filed: Jan. 25, 2008

(30) Foreign Application Priority Data
Jan. 31, 2007 (JP) 2007-22035

(51) Int. Cl. G06F 21/20

(52) U.S. Cl. 726/21

(57) ABSTRACT

An information processing method includes an input process of accepting information processing data as a subject of information processing in the case where prohibition of access from an arbitrary processing unit to plural execution memories that are set in a shared memory so as to correspond to kinds of exclusive controls which restrict access to the shared memory is set. A determining step determines, according to the information processing data accepted by the input step, and a kind of exclusive control for a processing unit that is selected by an OS. A permission setting step sets permission of access from the processing unit to an execution memory corresponding to the kind of exclusive control determined by the determining step, using a control function for setting permission or prohibition of access to the execution memory corresponding to the determined kind of exclusive control.

### TECHNICAL FIELD

The present invention relates to an information processing method, an information processing apparatus, and an information processing program for performing information processing in such a manner that access to a shared memory which is used in information processing is controlled by MMU (memory management unit) functions, as well as to a recording medium on which the information processing program is recorded.

### SUMMARY

The present invention provides an information processing method comprising an input process of accepting information processing data as a subject of information processing in the case where prohibition of access from an arbitrary processing unit to plural execution memories that are set in a shared memory so as to correspond to kinds of exclusive controls which restrict access to the shared memory is set; a determining step of determining, according to the information processing data accepted by the input step, a kind of exclusive control for a processing unit that is selected by an OS; a permission setting step of setting permission of access from the processing unit to an execution memory corresponding to the kind of exclusive control determined by the determining step, using a control function for setting permission or prohibition of access to the execution memory corresponding to the determined kind of exclusive control; and an executing step of executing the processing unit by accessing the execution memory if access to the execution memory is permitted by the permission setting step.

### BRIEF DESCRIPTION OF THE DRAWINGS

FIG. 1 is a block diagram showing the hardware configuration of an information processing apparatus according to an embodiment of the present invention;

FIG. 2 is a block diagram showing the functional configuration of the information processing apparatus according to the embodiment;

FIG. 3 is a chart outlining the information processing apparatus according to the embodiment;

FIG. 4 is a chart outlining a memory management DB according to the embodiment;

FIG. 5 is a chart outlining how access is made from a processing unit to an execution memory in an ordinary state in the embodiment;

FIG. 6 is a chart outlining how access is made from a processing unit to an execution memory in an interrupt prohibition state in the embodiment;

FIG. 7 is a chart outlining how access is made from a processing unit to an execution memory in a dispatch prohibition state in the embodiment;

FIG. 8 is a chart outlining how access is made from a processing unit to an execution memory in a semaphore-acquired state in the embodiment;

FIG. 9A is a flowchart of the entire process which is executed by the information processing apparatus according to the embodiment;

FIG. 9B is a flowchart showing the procedure of an exclusive process of an interrupt control in the information processing apparatus according to the embodiment;

FIG. 9C is a flowchart showing the procedure of an exclusive process of a dispatch control in the information processing apparatus according to the embodiment;

FIG. 9D is a flowchart showing the procedure of an exclusive process of a semaphore control in the information processing apparatus according to the embodiment;

FIG. 9E is a flowchart showing the procedure of a process that is executed at the occurrence of an exclusion leak in the information processing apparatus according to the embodiment;

FIG. 10 is a flowchart showing the procedure of an interrupt control process using an interrupt control function (steps S1001 and S1003 in FIG. 9B) in the embodiment;

FIG. 11 is a flowchart showing the procedure of a dispatch control process using a dispatch control function (steps S1201 and S1203 in FIG. 9C) in the embodiment;

FIG. 12 is a flowchart showing the procedure of a semaphore control process using a semaphore acquisition function (step S1401 in FIG. 9D) in the embodiment;

FIG. 13 is a flowchart showing the procedure of a semaphore control process using a semaphore freeing function (step S1403 in FIG. 9D) in the embodiment; and

FIG. 14 illustrates a conventional example of exclusion using MMU functions.

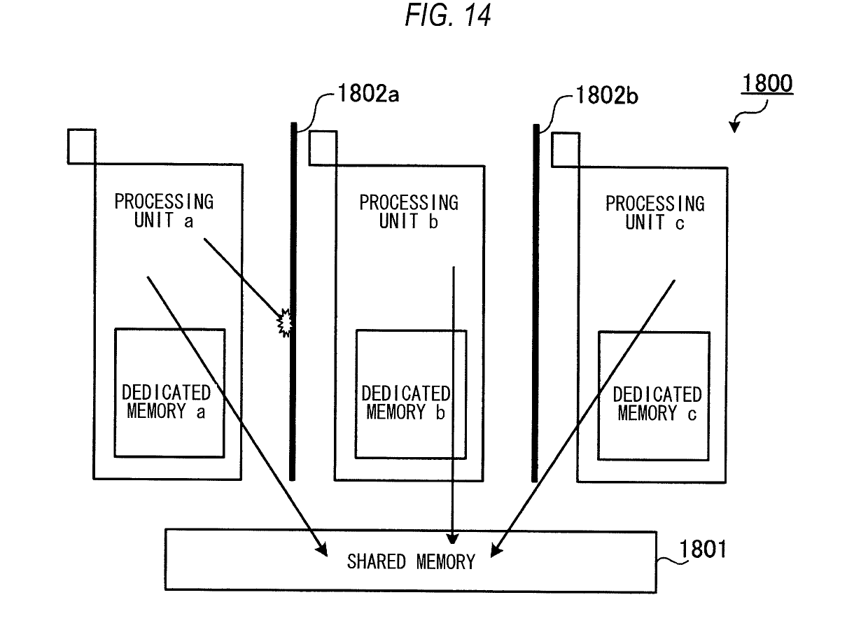

### DESCRIPTION OF THE PREFERRED EMBODIMENTS

Preferred embodiments of an information processing method, an information processing apparatus, an information processing program, and a recording medium on which the information processing program is recorded will be hereinafter described with reference to the accompanying drawings.

### Hardware Configuration of Information Processing Apparatus

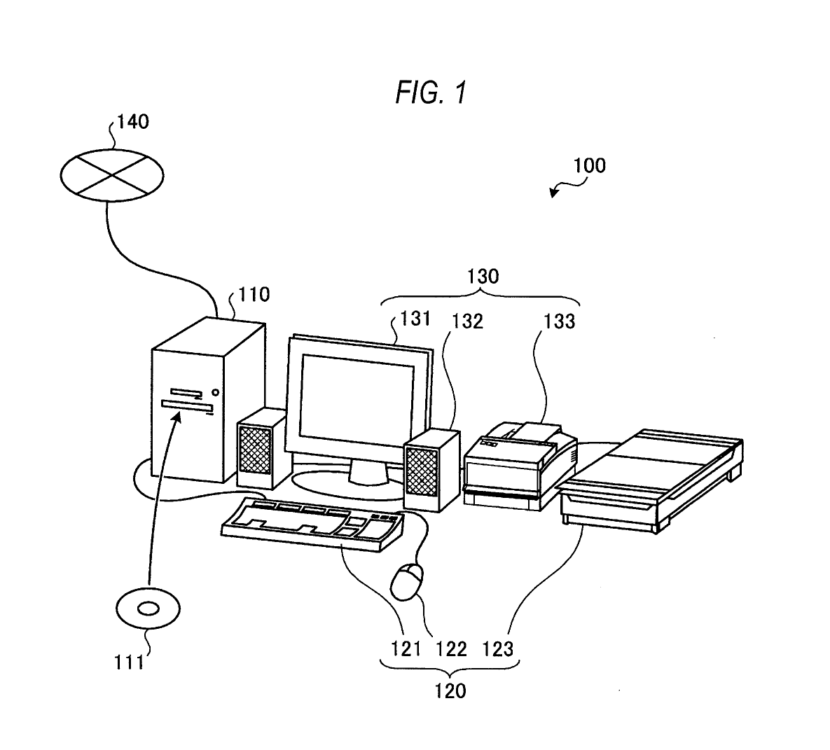

First, the hardware configuration of an information processing apparatus according to an embodiment will be described with reference to FIG. 1. FIG. 1 is a block diagram showing the hardware configuration of the information processing apparatus according to the embodiment.

As shown in FIG. 1, the information processing apparatus 100 is composed of a computer main body 110, input devices 120, and output devices 130 and can be connected to a network 140 such as a LAN, a WAN, or the Internet via a router or a modem (not shown).

The computer main body 110 is equipped with a CPU, memories, and an interface. The CPU controls the entire information processing apparatus 100. The memories are a ROM, a RAM, an HD, an optical disc 111, and a flash memory. The memories are used as work areas of the CPU.

Various programs are stored in the memories and loaded in response to a command from the CPU. Data writing and reading to and from each of the HD and the optical disc 111 are controlled by a disc drive. The optical disc 111 and the flash memory can be detached from the computer main body 110. The interface controls input from the input devices 120, output to the output devices 130, and transmission to and reception from the network 140.

The input devices 120 are a keyboard 121, a mouse 122, a scanner 123, etc. The keyboard 121 has keys for input of characters, numerals, various instructions, etc. and serves for input of data. The keyboard 121 may be of a touch panel type. The mouse 122 is used for cursor movement, range selection, movement and size change of a window, and other manipulations. The scanner 123 is used for reading an image optically. A read-out image is captured as image data and stored in the memories of the computer main body 110. The scanner 123 may have an OCR function.

The output devices 130 are a display 131, speakers 132, a printer 133, etc. The display 131 displays a cursor, icons, tool boxes, and data such as a document, an image, and function information. The speakers 132 output sounds such as an effect sound and a reading sound. The printer 133 prints image data and document data.

### Functional Configuration of Information Processing Apparatus

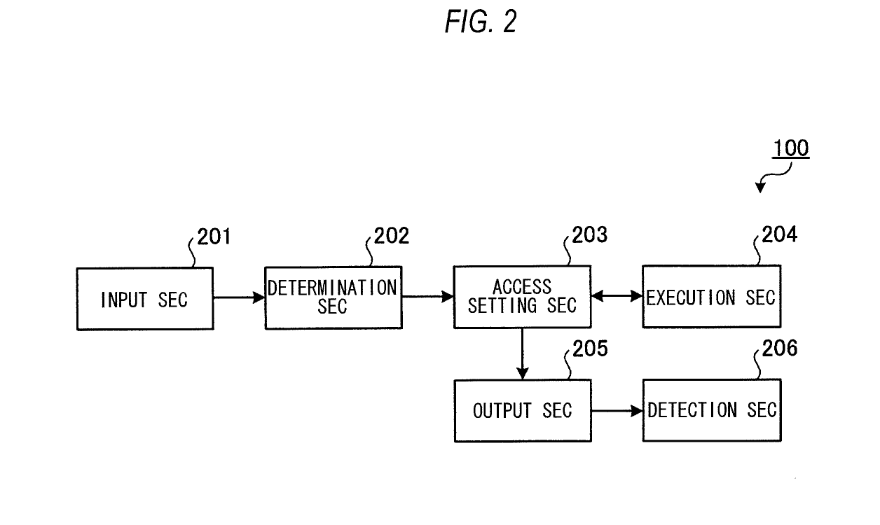

Next, the functional configuration of the information processing apparatus 100 according to the embodiment will be described with reference to FIG. 2. FIG. 2 is a block diagram showing the functional configuration of the information processing apparatus 100 according to the embodiment. As shown in FIG. 2, the information processing apparatus 100 is composed of an input section 201, a determination section 202, an access setting section 203, an execution section 204, an output section 205, and a detection section 206.

Where prohibition of access from an arbitrary processing unit to plural execution memories that are set in a shared memory (not shown) so as to correspond to kinds of exclusive controls which restrict access to the shared memory (not shown) is set, the input section 201 accepts information processing data as a subject of processing.

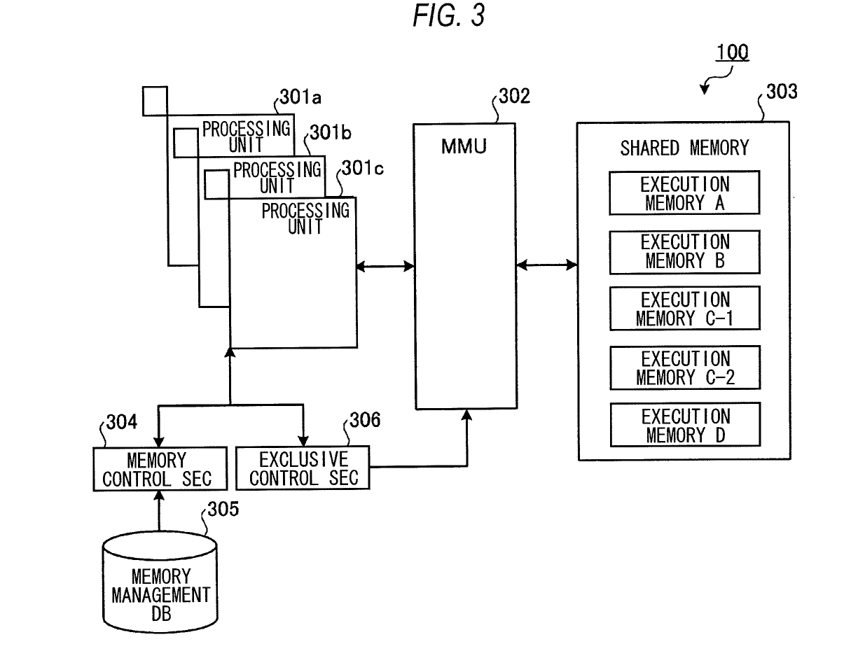

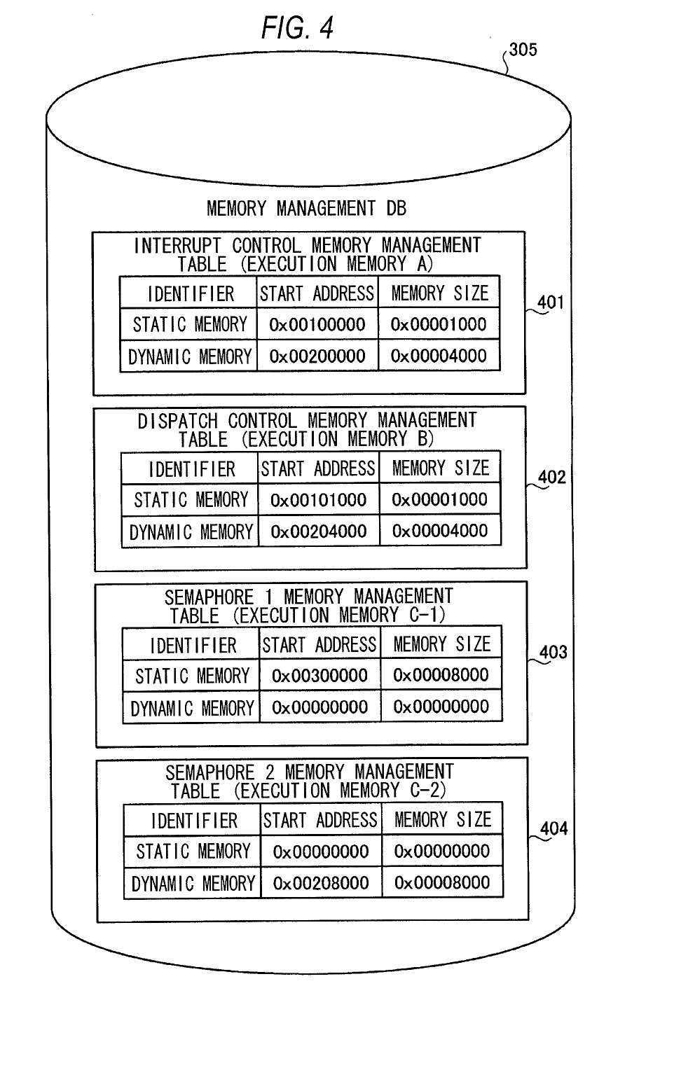

For example, the input section 201 accepts information processing data through the keyboard 121, the mouse 122, the scanner 123, or the network 140 shown in FIG. 1. Information processing data is stored in a buffer memory (not shown) or the like. As described later in detail with reference to FIGS. 3 and 4, at least one execution memory may be set in the shared memory for respective kinds of exclusive controls.

The determination section 202 determines a kind of exclusive control for a processing unit that is selected by the OS (operating system), according to information processing data that is accepted by the input section 201. For example, the determination section 202 may determine a kind of exclusive control according to a type of information processing of a processing unit.

For example, under the control of the CPU, the determination section 202 reads out information processing data stored in the buffer memory (not shown) or the like and determines a kind of exclusive control for a processing unit that is selected by the OS, according to a type of information processing. The determination section 202 stores the determined type of exclusive control in a buffer memory or the like.

The access setting section 203 sets permission or prohibition of access to an execution memory by a processing unit using a control function which sets permission or prohibition of access to an execution memory corresponding to a kind of exclusive control determined by the determination section 202. The information processing apparatus 100 may be configured in such a manner that the access setting section 203 re-sets prohibition of access to an execution memory when the execution section 204 has finished execution of a processing unit.

For example, under the control of the CPU, the access setting section 203 sets permission or prohibition of access to an execution memory from a processing unit using a control function corresponding to a kind of exclusive control stored in the buffer memory (not shown) or the like.

If access to an execution memory is permitted by the access setting section 203, the execution section 204 executes a processing unit by accessing the execution memory. For example, the execution section 204 executes a processing unit that is selected by the OS according to a type of information processing by accessing an execution memory that is access-permitted by the access setting section 203.

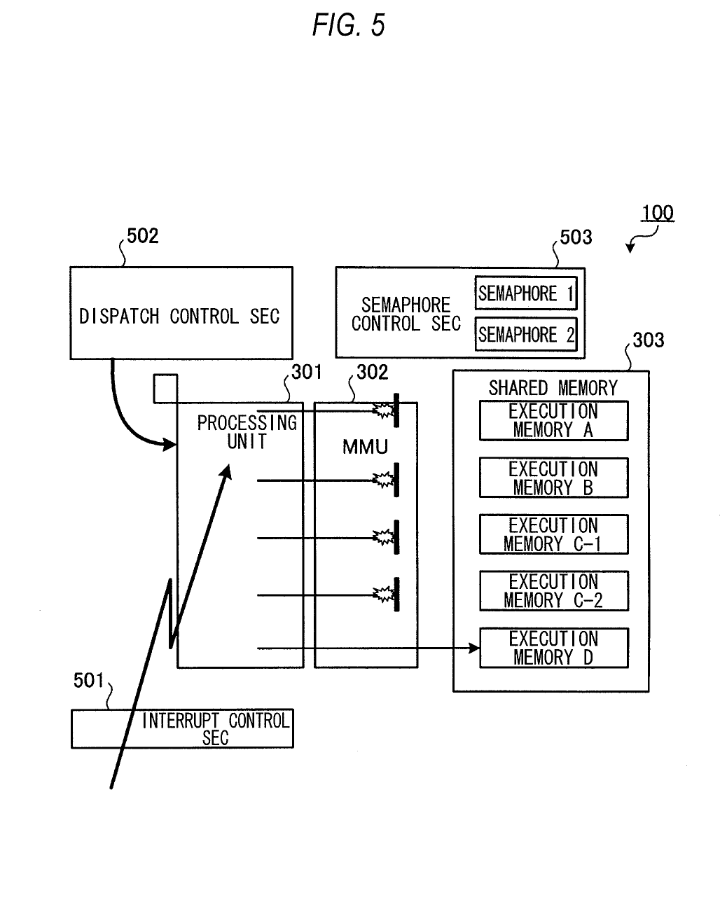

The output section 205 outputs an access error exception if a processing unit tries to access an execution memory before the access setting section 203 sets permission of access to the execution memory. As described later in detail with reference to FIGS. 5-8, an access error exception is output when, for example, a processing unit tries to access an access-prohibited execution memory.

For example, under the control of the CPU, the output section 205 outputs an access error exception when a processing unit tries to access an access-prohibition-set execution memory. The access error exception is stored in a buffer memory or the like.

The detection section 206 detects a location of occurrence of an error of access by a processing unit using an access error exception that is output from the output section 205. For example, under the control of the CPU, the detection section 206 detects a processing unit that has tried to access an access-prohibition-set execution memory, the execution memory, a time of occurrence using an access error exception stored in the buffer memory or the like.

Although not shown in FIG. 2, under the control of the CPU, the information processing apparatus 100 may stop its operation if the output section 205 outputs an access error exception. This prevents system failure of the information processing apparatus 100 which might otherwise occur due to continuation of the operation after the occurrence of the access error exception, and enables quick and proper debugging by detecting a location of occurrence of the access error.

### Outline of Information Processing Apparatus 100

Next, the information processing apparatus 100 according to the embodiment will be outlined with reference to FIG. 3. FIG. 3 is a chart outlining the information processing apparatus 100 according to the embodiment.

As shown in FIG. 3, the information processing apparatus 100 according to the embodiment is composed of processing units 301 (301a, 301b, and 301c), an MMU 302, a shared memory 303, a memory control section 304, a memory management DB (database) 305, and an exclusive control section 306.

The OS makes selection from the processing units 301. For example, each processing unit 301 is a processing routine such as a process, a thread, or a handler. The OS makes selection from the processing units 301 according to information processing data that is accepted by the input section 201 shown in FIG. 2.

The MMU 302 manages access to the shared memory 303 (described later) from each processing unit 301. As described later in detail with reference to FIGS. 5-8, the MMU 302 sets permission or prohibition of access from each processing unit 301 using a control function corresponding to a kind of exclusive control that is assigned by the exclusive control section 306 (described later).

If a processing unit 301 tries to access an access-prohibition-set execution memory, the MMU 302 outputs an access error exception and detects a location of occurrence of the access error. That is, for example, the MMU 302 is an implementation of the functions of the access setting section 203, the output section 205, and the detection section 206 shown in FIG. 2.

The shared memory 303 is a memory that is accessed by each processing unit 301. More specifically, for example, execution memories are set in the shared memory 303 so as to correspond to kinds of exclusive controls for the processing units 301.

As described later in detail with reference to FIG. 4, for example, the shared memory 303 consists of an execution memory A which is accessed with an interrupt control, an execution memory B which is accessed with a dispatch control, execution memories C-1 and C-2 which are accessed with a semaphore control, and an execution memory D which is accessed without performing an exclusive control. Pieces of information relating to the respective execution memories are contained in respective tables that are recorded in the memory management DB 305 in advance.

Each processing unit 301 is executed by accessing an execution memory that is set in the shared memory 303. That is, for example, the shared memory 303 is an implementation of the function of the execution section 204 shown in FIG. 2.

The memory control section 304 extracts, from the memory management DB 305, the address of an execution memory to be accessed by a processing unit 301. For example, the memory control section 304 extracts, from the memory management DB 305, the address of an execution memory using a kind of exclusive control for a processing unit 301 that is determined by the exclusive control section 306. That is, the memory control section 304, the memory management DB 305, and the exclusive control section 306 are an implementation of the function of the determination section 202 shown in FIG. 2.

Outline of Memory Management DB 305

Now, the memory management DB 305 will be outlined with reference to FIG. 4. [0056]

As shown in FIG. 4, an interrupt control memory management table 401, a dispatch control memory management table 402, a semaphore 1 memory management table 403, and a semaphore 2 memory management table 404 which relate to the execution memories which are set in advance so as to correspond to the kinds of exclusive controls for the processing units 301 are recorded in the memory management DB 305.

The interrupt control memory management table 401 contains information relating to the execution memory A which is accessed by each processing unit 301 when an interrupt prohibition state is established by an interrupt control.

The dispatch control memory management table 402 contains information relating to the execution memory B which is accessed by each processing unit 301 when a dispatch prohibition state is established by a dispatch control.

The semaphore 1 memory management table 403 and the semaphore 2 memory management table 404 contain information relating to the execution memories C-1 and C-2 which are accessed by each processing unit 301 when a semaphore-1-acquired state and a semaphore-2-acquired state are established by a semaphore control, respectively.

Although not shown in FIG. 4, for example, information relating to the execution memory D shown in FIG. 3 which is accessed without performing an exclusive control is recorded as information that is separate from the information relating to the execution memories A, B, C-1, and C-2 of the shared memory 303.

Memory identifiers, start addresses, and memory sizes are shown in each memory management table. The memory identifier is used for identifying a memory type such as a dynamic memory or a static memory. Each dynamic memory or static memory is set in the shared memory 303 in the form of a memory that is defined by a start address and a memory size. That is, a memory size being equal to “0” means that there is no corresponding memory.

The term “dynamic memory” means a memory area that is assigned by memory management of the OS. Dynamic memories are in many cases used for control and may be accessed by a processing unit 301 on condition that exclusion is established.

To manage dynamic memories on a memory level basis, the memory management of the OS assigns a memory from a memory area suitable for a memory level when the OS assigns a dynamic memory from a heap memory. Therefore, it is necessary for a memory request source to inform the OS of a memory level to acquire using an argument.

The term “static memory” means a BBS (block started by symbol) area of an external variable, a static variable, or the like. Static memories are in many cases accessed from plural processes and may be accessed by a processing unit 301 on condition that exclusion is established. To set static memories on a memory level basis, files are classified on a memory level basis, substantial memories are generated for the respective files, and memories are assigned on a file-by-file basis using a linker arrangement function.

### Outline of Access to Execution Memory by Processing Unit 301

Next, access to an execution memory by a processing unit 301 in the information processing apparatus 100 according to the embodiment will be outlined with reference to FIGS. 5-8. How access is made to an execution memory with each kind of exclusive control in an ordinary state (initial state), an interrupt prohibition state, a dispatch prohibition state, or a semaphore-acquired state will be described with reference to FIGS. 5-8.

FIG. 5 is a chart outlining how access is made from a processing unit 301 to an execution memory in an ordinary state in the embodiment. As shown in FIG. 5, the information processing apparatus 100 is composed of an interrupt control section 501, a dispatch control section 502, a semaphore control section 503, a processing unit 301, the MMU 302, and the shared memory 303.

For example, the interrupt control section 501, the dispatch control section 502, and the semaphore control section 503 are an implementation of the function of the exclusive control section 306 shown in FIG. 3. They assign the MMU 302 an exclusive control for access to an execution memory from the execution memory 301. In the ordinary state shown in FIG. 5, prohibition of access to each of the execution memories A, B, C-1, and C-2 from the processing unit 301 is set by the MMU 302.

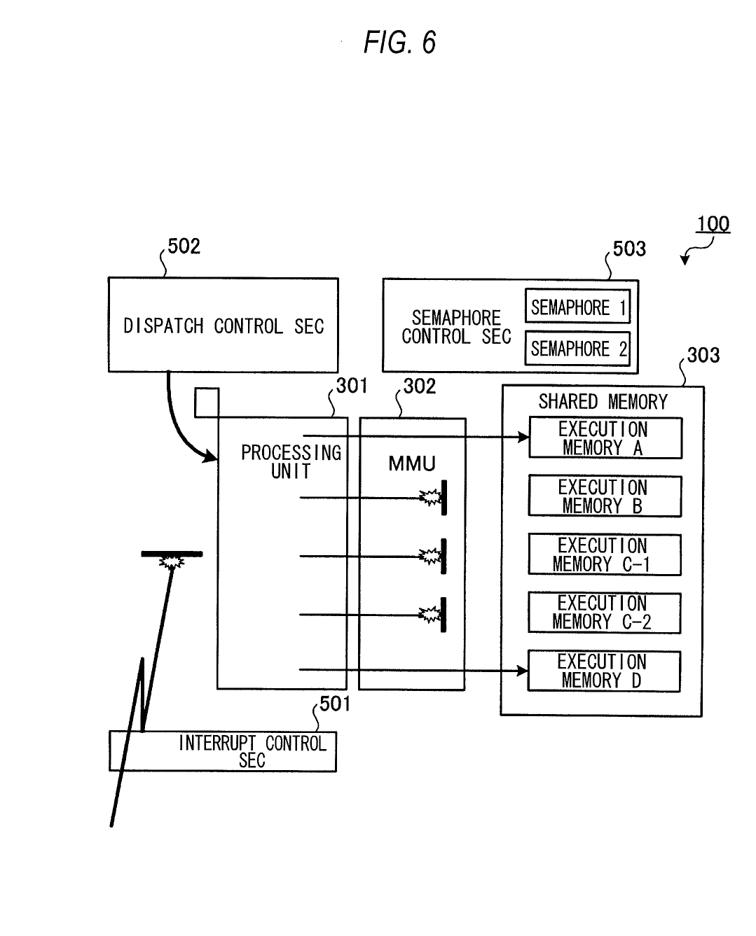

FIG. 6 is a chart outlining how access is made from a processing unit to an execution memory in an interrupt prohibition state in the embodiment. In FIG. 6, the execution memory A is set as a memory that is managed by the interrupt control section 501.

If it is determined that an interrupt prohibition state should be set as an exclusive control, the interrupt control section 501 establishes an interrupt prohibition state and instructs the MMU 302 to permit access to the execution memory A which corresponds to an interrupt prohibition state (exclusive control). In this manner, if the processing unit 301 is in an interrupt prohibition state, it can access the execution memory A.

If the interrupt prohibition state is canceled, the interrupt control section 501 instructs the MMU 302 to prohibit access to the execution memory A. If the execution memory A is accessed in a state that the interrupt prohibition state is canceled, the MMU 302 generates an MMU exception. A location of the exclusion leak is found quickly.

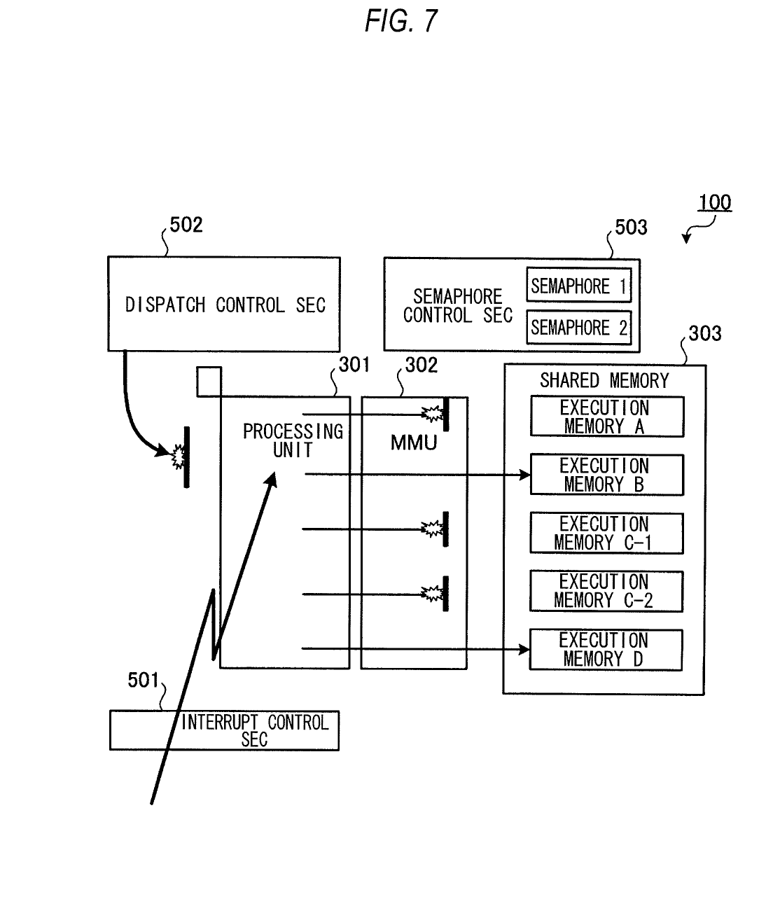

FIG. 7 is a chart outlining how access is made from a processing unit to an execution memory in a dispatch prohibition state in the embodiment. In FIG. 7, the execution memory B is set as a memory that is managed by the dispatch control section 502.

If it is determined that a dispatch prohibition state should be set as an exclusive control, the dispatch control section 502 establishes a dispatch prohibition state and instructs the MMU 302 to permit access to the execution memory B which corresponds to a dispatch prohibition state (exclusive control). In this manner, if the processing unit 301 is in a dispatch prohibition state, it can access the execution memory B.

If the dispatch prohibition state is canceled, the dispatch control section 502 instructs the MMU 302 to prohibit access to the execution memory B. If the execution memory B is accessed in a state that the dispatch prohibition state is canceled, the MMU 302 generates an MMU exception. A location of the exclusion leak is found quickly.

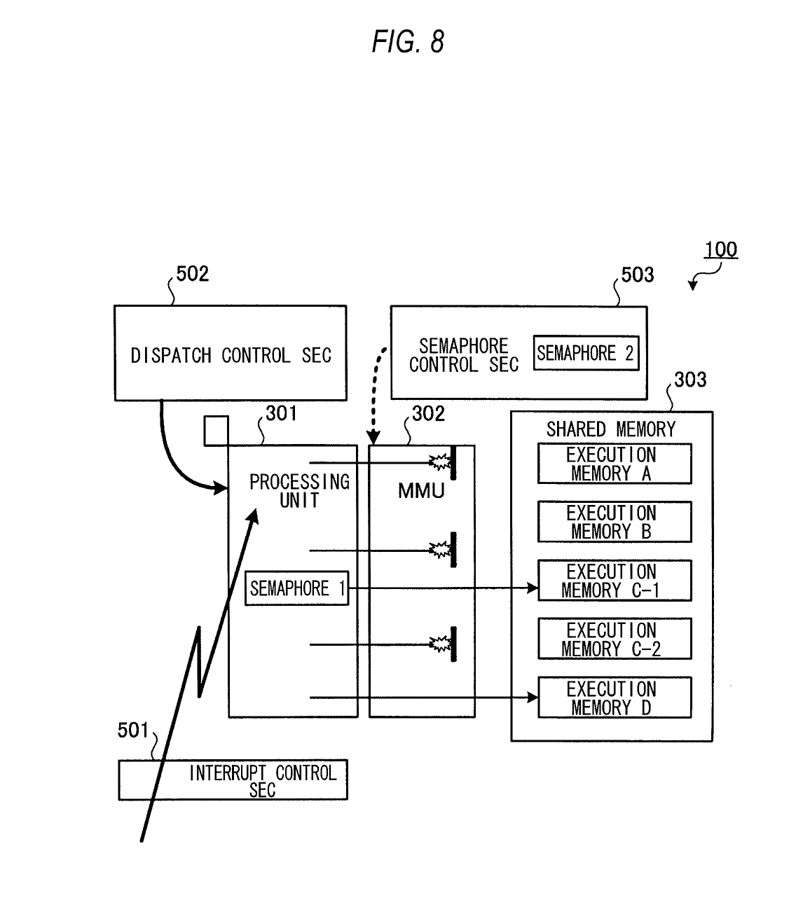

FIG. 8 is a chart outlining how access is made from a processing unit to an execution memory in a semaphore-acquired state in the embodiment. In FIG. 8, the execution memories C-1 and C-2 are set as memories that are managed by semaphore 1 and semaphore 2 provided in the semaphore control section 503, respectively.

If the processing unit 301 makes a semaphore acquisition request, the semaphore control section 503 assigns semaphore 1 to the processing unit 301 and instructs the MMU 302 to permit access to the execution memory C-1 which corresponds to semaphore 1. In this manner, if the processing unit 301 is in a semaphore-1-acquired state, it can access the execution memory C-1.

If the processing unit 301 returns semaphore 1 to the semaphore control section 503, the semaphore control section 503 instructs the MMU 302 to prohibit access to the execution memory C-1 which corresponds to semaphore 1. If the processing unit 301 accesses the execution memory C-1 in a state that it has not acquired semaphore 1, the MMU 302 generates an MMU exception. A location of the exclusion leak is found quickly.

### Process Executed by Information Processing Apparatus 100

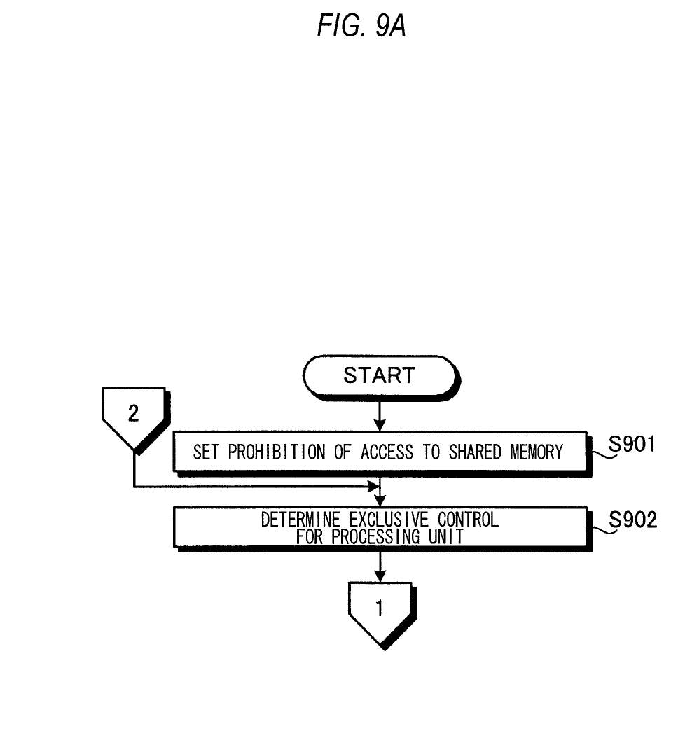

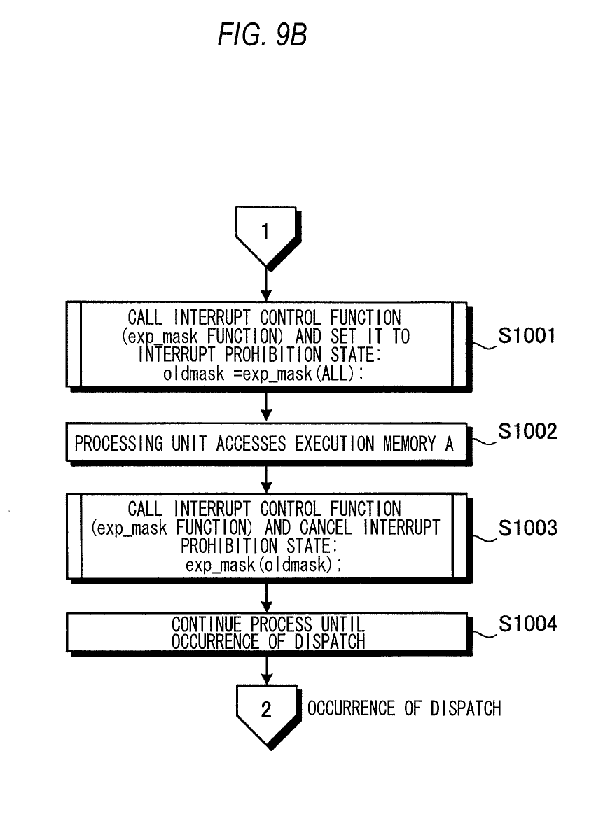

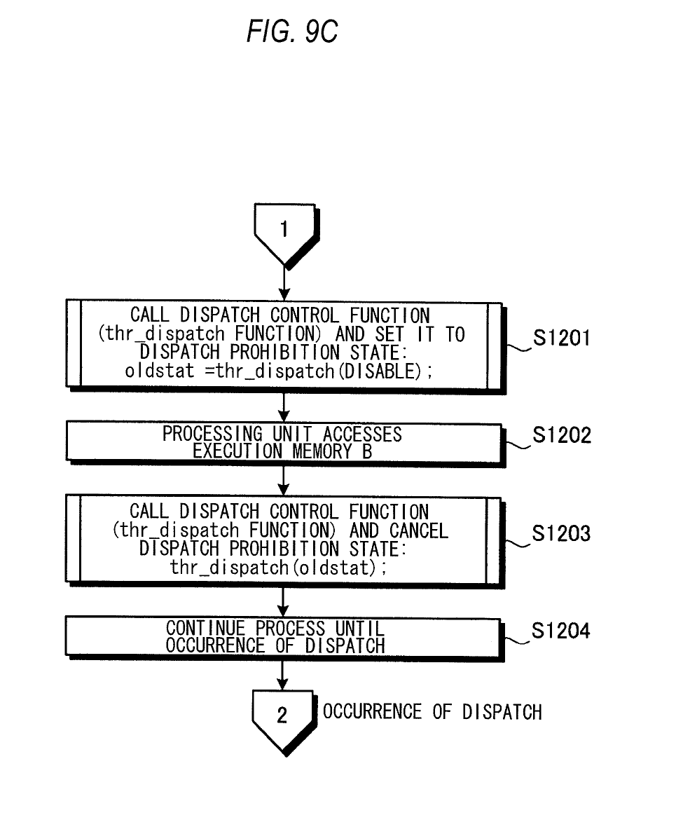

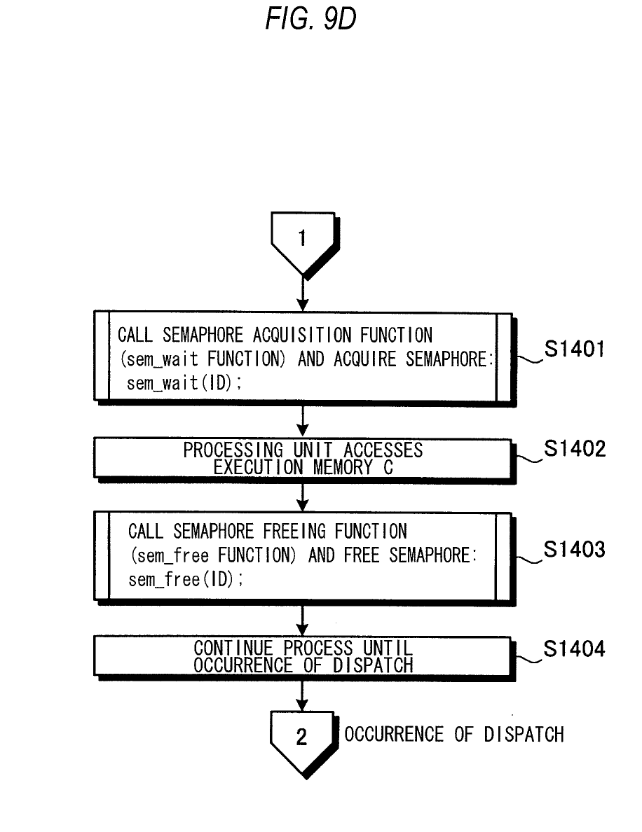

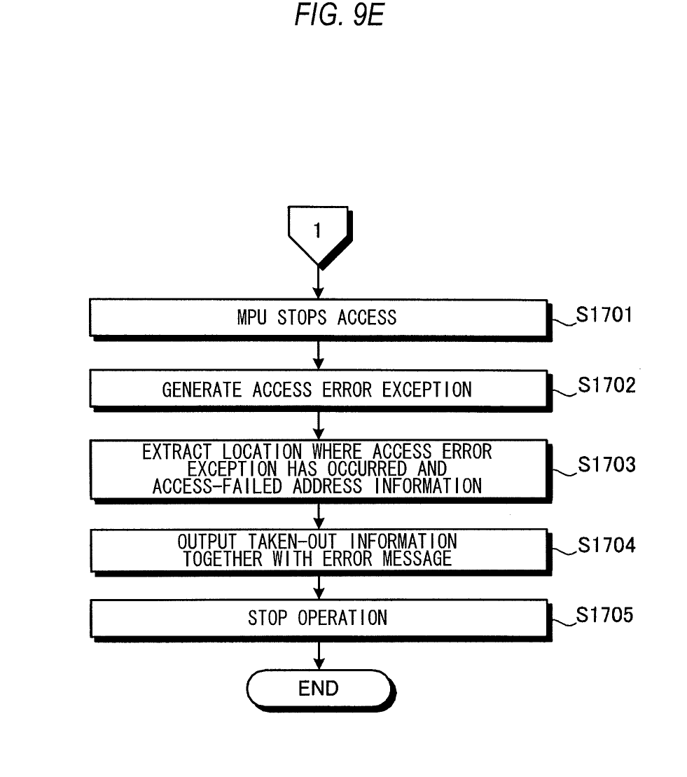

Next, a process executed by the information processing apparatus 100 according to the embodiment will be described with reference to FIGS. 9A-9E. FIG. 9A is a flowchart of the entire process which is executed by the information processing apparatus 100 according to the embodiment. As shown in the flowchart of FIG. 9A, first, at step S901, upon activation of the information processing apparatus 100, the MMU 302 sets prohibition of access to the shared memory 303 by referring to the tables recorded in the memory management DB 305.

At step S902, the OS determines an exclusive control for a processing unit 301 according to information processing data that is input to the information processing apparatus 100. The exclusive control determined at step S902 is an interrupt control, a dispatch control, a semaphore control, or the like. The processing units 301 are switched according to the determined exclusive control every time a dispatch occurs, whereby one of control processes shown in FIGS. 9B-9D is executed.

### Procedure of Interrupt Control Process

First, the procedure of an exclusive process of an interrupt control in the information processing apparatus 100 according to the embodiment will be described with reference to FIG. 9B. FIG. 9B is a flowchart showing the procedure of the exclusive process of an interrupt control in the information processing apparatus 100 according to the embodiment.

If the exclusive control determined at step S902 in FIG. 9A is an interrupt control, the processing unit 301 is to access the execution memory A. Therefore, at step S1001 in FIG. 9B, the MMU 302 calls an interrupt control function (exp_mask function) and sets it to an interrupt prohibition state (oldmask=exp_mask(ALL);). The interrupt control function is stored in one of the memories such as the ROM, RAM, HD, optical disk 111, and flash memory and is called under the control of the CPU.

At step 1002, the processing unit 301 accesses the execution memory A because the execution memory A access prohibition state was cancelled at step S1001 by the called interrupt control function.

Upon completion of the access at step 1002, to cancel the exclusion the MMU 302 calls the interrupt control function (exp_mask function) and cancels the interrupt prohibition state (exp_mask(oldmask);) at step S1003. As a result, a state that access to the execution memory A is prohibited is established.

At step S1004, the information processing apparatus 100 continues the process until occurrence of a dispatch. Upon occurrence of a dispatch, the process returns to step S902 in FIG. 9A and repeats the same process.

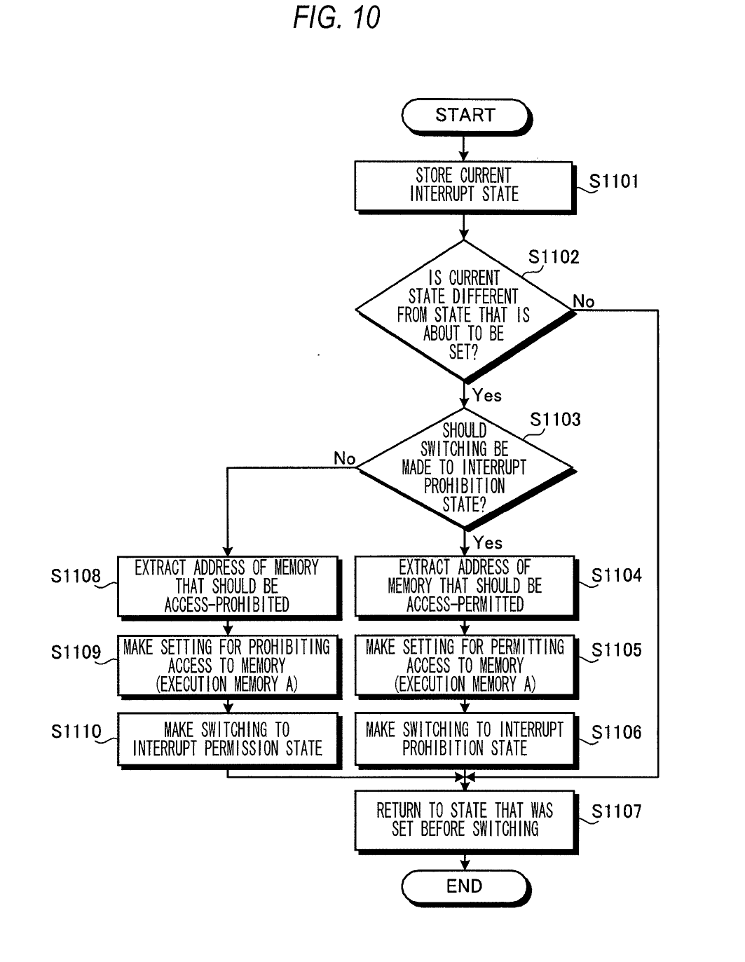

Now, the procedure of the interrupt control process using the interrupt control function (steps S1001 and S1003 in FIG. 9B) in the information processing apparatus 100 according to the embodiment will be described with reference to FIG. 10. FIG. 10 is a flowchart showing the procedure of the interrupt control process using the interrupt control function (steps S1001 and S1003 in FIG. 9B) in the embodiment.

In the flowchart of FIG. 10, first, at step S1101, the information processing apparatus 100 stores the current interrupt state using the interrupt control function. The current interrupt state is stored in one of the memories such as the ROM, RAM, HD, optical disk 111, and flash memory to enable returning to the same interrupt state as the previous one, for example, upon completion of access by the processing unit 301.

At step S1102, the OS of the information processing apparatus 100 judges whether or not the current state is different from the state that is about to be set. If the current state is different from the state that is about to be set (step S1102: yes), at step S1103 the OS of the information processing apparatus 100 judges whether to switch to an interrupt prohibition state.

If it is judged at step S1103 that switching should be made to an interrupt prohibition state (step S1103: yes), at step S1104 the memory control section 304 of the information processing apparatus 100 extracts the address of a memory that should be access-permitted in an interrupt prohibition state by referring to the tables recorded in the memory management DB 305.

At step S1105, the exclusive control section 306 of the information processing apparatus 100 makes a setting for permitting the memory extracted at step S1104 (i.e., execution memory A) to access the MMU 302.

At step S1106, the MMU 302 of the information processing apparatus 100 makes switching to an interrupt prohibition state according to the permission setting which was made at step S1105. At step S1107, return is made to the state that was set before the switching. Then, the information processing apparatus 100 finishes the series of interrupt control steps.

If it is judged at step S1103 that switching should not be made to an interrupt prohibition state (step S1103: no), at step S1108 the memory control section 304 of the information processing apparatus 100 extracts the address of a memory that should be access-prohibited in an interrupt permission state by referring to the tables recorded in the memory management DB 305.

At step S1109, the exclusive control section 306 of the information processing apparatus 100 makes a setting for prohibiting the memory extracted at step S1108 (i.e., execution memory A) from accessing the MMU 302.

At step S1110, the MMU 302 of the information processing apparatus 100 makes switching to an interrupt permission state according to the prohibition setting which was made at step S1109. At step S1107, return is made to the state that was set before the switching. Then, the information processing apparatus 100 finishes the series of interrupt control steps.

If it is judged at step S1102 that the current state is the same as the state that is about to be set (step S1102: no), the information processing apparatus 100 moves to step S1107, where the current state is regarded as the state that was set before the switching and return is made to the state that was set before the switching. Then, the information processing apparatus 100 finishes the series of interrupt control steps.

### Procedure of Dispatch Control Process

Next, the procedure of an exclusive process of a dispatch control in the information processing apparatus 100 according to the embodiment will be described with reference to FIG. 9C. FIG. 9C is a flowchart showing the procedure of the exclusive process of a dispatch control in the information processing apparatus 100 according to the embodiment.

If the exclusive control determined at step S902 in FIG. 9A is a dispatch control, the processing unit 301 is to access the execution memory B. Therefore, at step S1201 in FIG. 9C, the MMU 302 calls a dispatch control function (thr_dispatch function) and sets it to a dispatch prohibition state (oldstat=thr_dispatch(DISABLE);). The dispatch control function is stored in one of the memories such as the ROM, RAM, HD, optical disk 111, and flash memory and is called under the control of the CPU.

At step 1202, the processing unit 301 accesses the execution memory B because the execution memory B access prohibition state was cancelled at step S1201 by the called dispatch control function.

Upon completion of the access at step 1202, to cancel the exclusion the MMU 302 calls the dispatch control function (thr_dispatch function) and cancels the dispatch prohibition state (thr_dispatch(oldstat);) at step S1203. As a result, a state that access to the execution memory B is prohibited is established.

At step S1204, the information processing apparatus 100 continues the process until occurrence of a dispatch. Upon occurrence of a dispatch, the process returns to step S902 in FIG. 9A and repeats the same process.

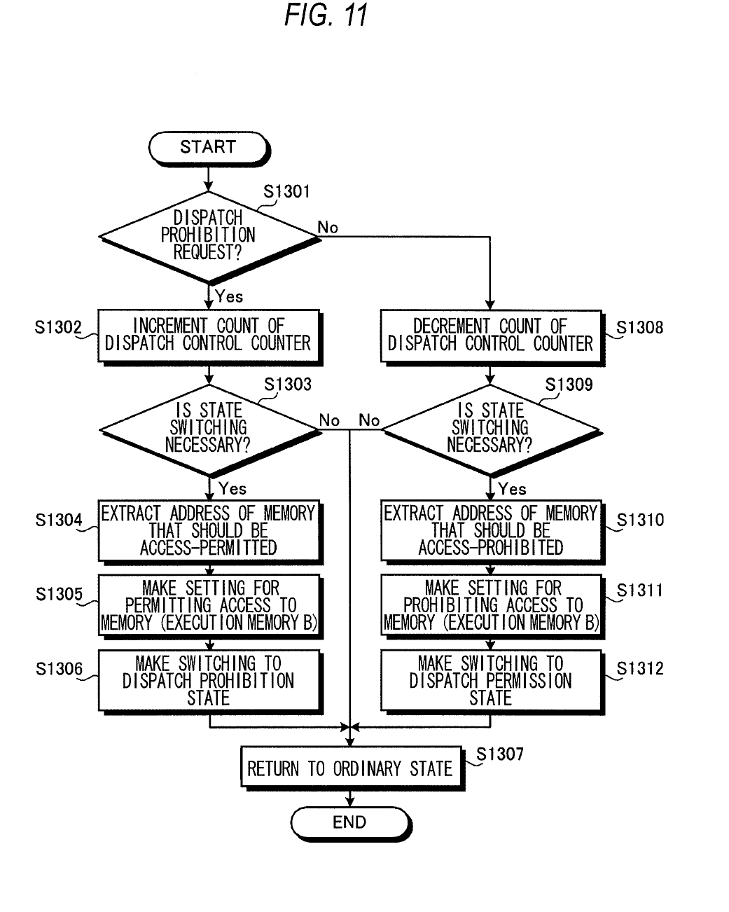

Now, the procedure of the dispatch control process using the dispatch control function (steps S1201 and S1203 in FIG. 9c) in the information processing apparatus 100 according to the embodiment will be described with reference to FIG. 11. FIG. 11 is a flowchart showing the procedure of the dispatch control process using the dispatch control function (steps S1201 and S1203 in FIG. 9C) in the embodiment.

In the flowchart of FIG. 11, first, at step S1301, the information processing apparatus 100 judges, using the dispatch control function, whether or not the request is a dispatch prohibition request from the OS. If it is judged at step 1301 that the request is a dispatch prohibition request (step S1301: yes), at step S1302 the information processing apparatus 100 increments the count of a dispatch control counter (not shown).

At step S1303, the OS judges whether or not state switching is necessary on the basis of the count of the dispatch control counter that was incremented at step S1302. More specifically, for example, the information processing apparatus 100 judges that state switching is necessary if the count of the dispatch control counter is “1,” and judges that state switching is not necessary if the count of the dispatch control counter is larger than or equal to “2” because a dispatch prohibition state has already been established.

If it is judged at step S1303 that state switching is necessary (step S1303: yes), at step S1304 the memory control section 304 of the information processing apparatus 100 extracts the address of a memory that should be access-permitted in a dispatch prohibition state by referring to the tables recorded in the memory management DB 305.

At step S1305, the exclusive control section 306 of the information processing apparatus 100 makes a setting for permitting the memory extracted at step S1304 (i.e., execution memory B) to access the MMU 302.

At step S1306, the MMU 302 of the information processing apparatus 100 makes switching to a dispatch prohibition state according to the permission setting which was made at step S1305. The information processing apparatus 100 returns to an ordinary state at step S1307, and then finishes the series of dispatch control steps.

If it is judged at step S1303 that state switching is not necessary (step S1303: no), the information processing apparatus 100 returns to an ordinary state at step S1307 and then finishes the series of dispatch control steps.

If it is judged at step S1301 that the request is not a dispatch prohibition request (step S1301: no), at step S1308 the information processing apparatus 100 decrements the count of the dispatch control counter (not shown). In other words, the count of the dispatch control counter is decremented if the request is a dispatch permission request.

At step S1309, the OS judges whether or not state switching is necessary on the basis of the count of the dispatch control counter that was decremented at step S1308. More specifically, for example, the information processing apparatus 100 judges that state switching is necessary if the count of the dispatch control counter is “0,” and judges that state switching is not necessary, that is, the dispatch prohibition state should be maintained, if the count of the dispatch control counter is larger than or equal to “1.”.

If it is judged at step S1309 that state switching is necessary (step S1309: yes), at step S1310 the memory control section 304 of the information processing apparatus 100 extracts the address of a memory that should be access-prohibited in a dispatch permission state by referring to the tables recorded in the memory management DB 305.

At step S1311, the exclusive control section 306 of the information processing apparatus 100 makes a setting for prohibiting the memory extracted at step S1310 (i.e., execution memory B) from accessing the MMU 302.

At step 1312, the MMU 302 of the information processing apparatus 100 makes switching to a dispatch permission state according to the prohibition setting which was made at step S1311. The information processing apparatus 100 returns to an ordinary state at step S1307, and then finishes the series of dispatch control steps.

If it is judged at step S1309 that state switching is not necessary (step S1309: no), the information processing apparatus 100 returns to an ordinary state at step S1307 and then finishes the series of dispatch control steps.

### Procedure of Semaphore Control Process

Next, the procedure of an exclusive process of a semaphore control in the information processing apparatus 100 according to the embodiment will be described with reference to FIG. 9D. FIG. 9D is a flowchart showing the procedure of the exclusive process of a semaphore control in the information processing apparatus 100 according to the embodiment.

If the exclusive control determined at step S902 in FIG. 9A is a semaphore control, the processing unit 301 is to access an execution memory C (execution memory C-1 or C-2). Therefore, at step S1401 in FIG. 9D, the MMU 302 calls a semaphore acquisition function (sem_wait function) and acquires a semaphore (sem_wait(ID);). The semaphore acquisition function is stored in one of the memories such as the ROM, RAM, HD, optical disk 111, and flash memory and is called under the control of the CPU.

At step 1402, the processing unit 301 which has acquired the semaphore accesses the execution memory C because the execution memory C access prohibition state was cancelled at step S1401 by the called semaphore acquisition function.

Upon completion of the access at step S1402, to cancel the exclusion the MMU 302 of the information processing apparatus 100 calls the semaphore freeing function (sem_free function) andfrees the semaphore (sem_free(ID);) at step S1403. As a result, a state that access to the execution memory C is prohibited is established.

At step S1404, the information processing apparatus 100 continues the process until occurrence of a dispatch. Upon occurrence of a dispatch, the process returns to step S902 in FIG. 9A and repeats the same process.

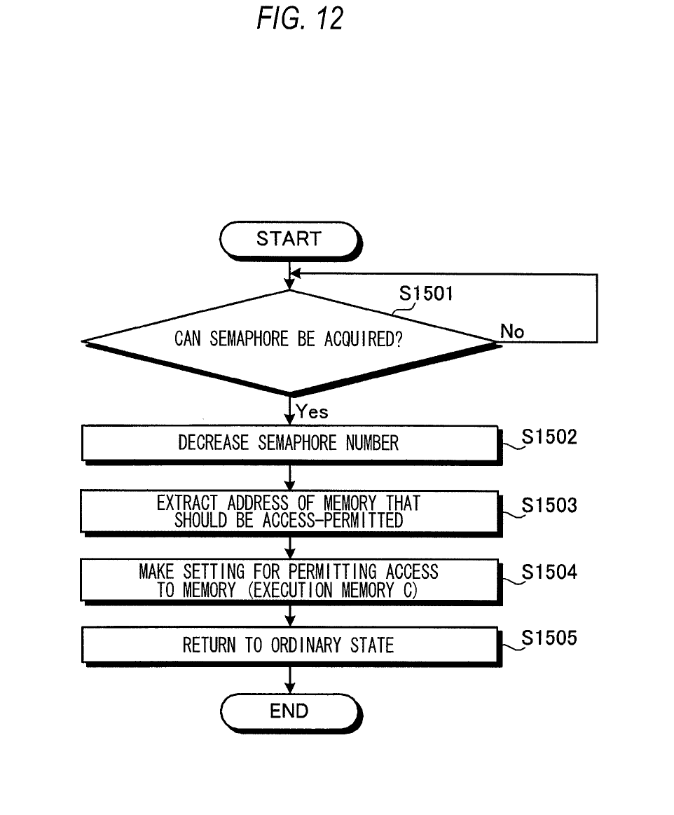

Now, the procedure of the semaphore control process using the semaphore acquisition function (step S1401 in FIG. 9D) in the information processing apparatus 100 according to the embodiment will be described with reference to FIG. 12. FIG. 12 is a flowchart showing the procedure of the semaphore control process using the semaphore acquisition function (step S1401 in FIG. 9D) in the embodiment.

In the flowchart of FIG. 12, first, at step S1501, the information processing apparatus 100 judges whether or not a semaphore can be acquired by the semaphore acquisition function. More specifically, for example, whether or not a semaphore can be acquired is judged by judging whether or not the semaphore control section 503 can assign semaphore 1 or semaphore 2.

The information processing apparatus 100 waits for acquisition of a semaphore while executing step S1501 repeatedly. If a semaphore is acquired (step S1501: yes), at step S1502 the information processing apparatus 100 decreases a semaphore number in the semaphore control section 503. More specifically, for example, the semaphore number reduction results in a state that only semaphore 2 remains in the semaphore control section 503 while semaphore 1 is assigned.

At step S1503, the memory control section 304 of the information processing apparatus 100 extracts the address of a memory that should be access-permitted in a semaphore-acquired state by referring to the tables recorded in the memory management DB 305.

At step S1504, the exclusive control section 306 of the information processing apparatus 100 makes a setting for permitting the memory extracted at step S1503 (i.e., execution memory C) to access the MMU 302. The information processing apparatus 100 returns to an ordinary state at step S1505, and then finishes the series of semaphore control steps using the semaphore acquisition function.

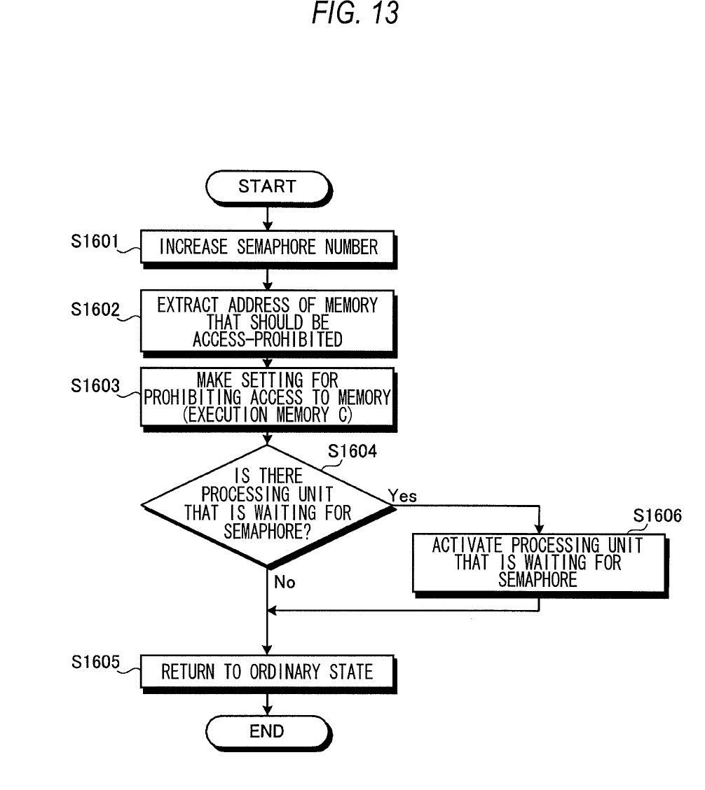

Next, the procedure of the semaphore control process using the semaphore freeing function (step S1403 in FIG. 9D) in the information processing apparatus 100 according to the embodiment of the invention will be described with reference to FIG. 13. FIG. 13 is a flowchart showing the procedure of the semaphore control process using the semaphore acquisition function (step S1403 in FIG. 9D) in the embodiment of the invention.

In the flowchart of FIG. 13, first, at step S1601, the information processing apparatus 100 increases the semaphore number using the semaphore freeing function. More specifically, for example, the semaphore number increase is such that if the semaphore control section 503 assigned semaphore 1, for example, semaphore 1 is returned and semaphore 1 and semaphore 2 come to exist in the semaphore control section 503.

At step S1602, the memory control section 304 of the information processing apparatus 100 extracts the address of a memory that should be access-prohibited in a semaphore-freed state by referring to the tables recorded in the memory management DB 305.

At step S1603, the exclusive control section 306 of the information processing apparatus 100 makes a setting for prohibiting the memory extracted at step S1602 (i.e., execution memory C) from accessing the MMU 302.

At step S1604, the semaphore control section 503 of the information processing apparatus 100 judges whether or not there exists a processing unit 301 that is waiting for a semaphore. If it is judged at step S1604 that there is no such processing unit 301 (step S1604: no), the information processing apparatus 100 returns to an ordinary state at step S1605 and then finishes the series of semaphore control steps using the semaphore freeing function.

If it is judged at step S1604 that there exists a processing unit 301 that is waiting for a semaphore (step S1604: yes), at step S1606 the information processing apparatus 100 activates the processing unit 301 that is waiting for a semaphore. The information processing apparatus 100 returns to an ordinary state at step S1605, and then finishes the series of semaphore control steps using the semaphore freeing function.

Although in FIGS. 9(b)-9(d) and 10-13 the separate processes are provided for the respective exclusive controls, a processing unit 301 may execute an exclusive process of a combination of plural kinds of exclusive controls. For example, it is possible to combine an interrupt control process and a dispatch control process or an interrupt control process and a semaphore control process in which the constituent control processes may be executed in arbitrary order.

Procedure of Process that is Executed at the Occurrence of Exclusion Leak

Next, the procedure of a process that is executed at the occurrence of an exclusion leak in the information processing apparatus 100 according to the embodiment will be described with reference to FIG. 9E. FIG. 9E is a flowchart showing the procedure of the process that is executed at the occurrence of an exclusion leak in the information processing apparatus 100 according to the embodiment.

In the flowchart of FIG. 9E, first, if the processing unit 301 tries to access the execution memory without calling the control function for the exclusive control (see FIG. 9B, 9C, or 9D) by the information processing apparatus 100, at step S1701 the MMU 302 stops the access. For example, even if the processing unit 301 tries to access the execution memory A without calling the interrupt control function, it cannot access the execution memory A because access to the execution memory A is prohibited by the MMU 302.

When the access from the processing unit 301 to the execution memory is stopped at step S1701, at step S1702 the MMU 302 generates an access error exception.

At step S1703, the OS extracts a location where the access error exception has occurred and access-failed address information from the access error exception that was generated at step S1702. More specifically, for example, when an access error exception has occurred, a location where the access error exception has occurred and access-failed address information are stored in a register of the CPU and the OS reads out the information stored in the register.

At step S1704, under the control of the CPU, the information processing apparatus 100 outputs, together with an error message, the information taken out. The information processing apparatus 100 stops its operation at step S1705 and finishes the series of steps.

For example, the information output at step S1704 may be such that the information is output through a display device or the like or recorded by outputting it to a log file. Each of these measures makes it possible to identify an exclusion leak easily and hence to debug the exclusion leak quickly and efficiently.

As described above, according to the embodiment, execution memories corresponding to kinds of exclusion controls are set in the shared memory and the MMU can make a permission or prohibition setting for access to an execution memory using a control function corresponding to a kind of exclusive control for each processing unit. Therefore, the manner of use of the shared memory can be optimized by properly arbitrating contention of accesses to the shared memory through exclusive controls. That is, since access to an execution memory corresponding to an interrupt control is permitted, a processing unit can use the shared memory properly even in the case of an interrupt control using a handler or the like.

Furthermore, according to the embodiment, if access is made to the shared memory without using a control function, an access error exception occurs, whereby the operation of the information processing apparatus can be stopped. Therefore, a location where an access error has occurred due to an exclusion leak can be determined easily and debugging can be performed efficiently.

The information processing method according to the embodiment can be realized by causing a computer such as a personal computer or a workstation to run programs that are prepared in advance. These programs are recorded on a computer-readable recording medium such as a hard disk, a flexible disk, a CD-ROM, an MO, and a DVD and are run after being read from the recording medium by a computer. Alternatively, these programs may be distributed over a transmission medium, an example of which is a network such as the Internet.

What is claimed is:

1. An information processing method comprising:
an input process of accepting information processing data as a subject of information processing in the case where prohibition of access from an arbitrary processing unit to plural execution memories that are set in a shared memory so as to correspond to kinds of exclusive controls which restrict access to the shared memory is set;
a determining step of determining, according to the information processing data accepted by the input step, a kind of exclusive control for a processing unit that is selected by an OS;
a permission setting step of setting permission of access from the processing unit to an execution memory corresponding to the kind of exclusive control determined by the determining step, using a control function for setting permission or prohibition of access to the execution memory corresponding to the determined kind of exclusive control; and
an executing step of executing the processing unit by accessing the execution memory if access to the execution memory is permitted by the permission setting step.

2. The information processing method according to claim 1, further comprising a prohibition setting step of re-setting prohibition of access to the execution memory using the control function when the execution of the processing unit by the executing step has finished.

3. The information processing method according to claim 1, wherein the determining step determines a kind of exclusive control according to a type of information processing of the processing unit.

4. The information processing method according to claim 1, wherein the plural execution memories are set in the shared memory for the respective kinds of exclusive controls.

5. The information processing method according to claim 1, further comprising an output step of outputting an access error exception if the processing unit tries to access the execution memory before the permission setting step permits access to the execution memory.

6. The information processing method according to claim 5, further comprising a detecting step of detecting a location of occurrence of an error of the access from the processing unit, on the basis of the access error exception that is output by the output step.

7. An information processing apparatus comprising:
input means for accepting information processing data as a subject of information processing in the case where prohibition of access from an arbitrary processing unit to plural execution memories that are set in a shared memory so as to correspond to kinds of exclusive controls which restrict access to the shared memory is set;
determining means for determining, according to the information processing data accepted by the input means, a kind of exclusive control for a processing unit that is selected by an OS;
permission setting means for setting permission of access from the processing unit to an execution memory corresponding to the kind of exclusive control determined by the determining means, using a control function for setting permission or prohibition of access to the execution memory corresponding to the determined kind of exclusive control; and
executing means for executing the processing unit by accessing the execution memory if access to the execution memory is permitted by the permission setting means.

8. The information processing apparatus according to claim 7, further comprising prohibition setting means for re-setting prohibition of access to the execution memory using the control function when the execution of the processing unit by the executing means has finished.

9. The information processing apparatus according to claim 7, wherein the determining means determines a kind of exclusive control according to a type of information processing of the processing unit.

10. The information processing apparatus according to claim 7, wherein the plural execution memories are set in the shared memory for the respective kinds of exclusive controls.

11. The information processing apparatus according to claim 7, further comprising output means for outputting an access error exception if the processing unit tries to access the execution memory before the permission setting means permits access to the execution memory.

12. The information processing apparatus according to claim 11, further comprising detecting means for detecting a location of occurrence of an error of the access from the processing unit, on the basis of the access error exception that is output by the output means.

13. A computer-readable recording medium on which an information processing program is recorded, the information processing program causing a computer to execute:
an input process of accepting information processing data as a subject of information processing in the case where prohibition of access from an arbitrary processing unit to plural execution memories that are set in a shared memory so as to correspond to kinds of exclusive controls which restrict access to the shared memory is set;
a determining step of determining, according to the information processing data accepted by the input step, a kind of exclusive control for a processing unit that is selected by an OS;
a permission setting step of setting permission of access from the processing unit to an execution memory corresponding to the kind of exclusive control determined by the determining step, using a control function for setting permission or prohibition of access to the execution memory corresponding to the determined kind of exclusive control; and
an executing step of executing the processing unit by accessing the execution memory if access to the execution memory is permitted by the permission setting step.

14. The computer-readable recording medium according to claim 13 on which an information processing program is recorded, wherein the program causes the computer to further execute a prohibition setting step of re-setting prohibition of access to the execution memory using the control function when the execution of the processing unit by the executing step has finished.

15. The computer-readable recording medium according to claim 13, wherein the determining step determines a kind of exclusive control according to a type of information processing of the processing unit.

16. The computer-readable recording medium according to claim 13, wherein the plural execution memories are set in the shared memory for the respective kinds of exclusive controls.

17. The computer-readable recording medium according to claim 13, wherein the program causes the computer to further execute an output step of outputting an access error exception if the processing unit tries to access the execution memory before the permission setting step permits access to the execution memory.

18. The computer-readable recording medium according to claim 17, wherein the program causes the computer to further execute a detecting step of detecting a location of occurrence of an error of the access from the processing unit, on the basis of the access error exception that is output by the output step.
